(19) United States
(12) Patent Application Publication
(10) Pub. No.: US 2014/0049445 A1
(43) Pub. Date: Feb. 20, 2014

(54) DUAL FREQUENCY ANTENNA MODULE

(71) Applicant: HON HAI PRECISION INDUSTRY CO., LTD., Tu-Cheng (TW)

(72) Inventor: HSIN-LUNG TU, Tu-Cheng (TW)

(73) Assignee: HON HAI PRECISION INDUSTRY CO., LTD., Tu-Cheng (TW)

(21) Appl. No.: 13/626,854

(22) Filed: Sep. 25, 2012

(30) Foreign Application Priority Data
Aug. 20, 2012 (TW) 101130178

(51) Int. Cl. H01Q 5/01; H01Q 21/00

(52) U.S. Cl. 343/893

(57) ABSTRACT

A dual frequency antenna module is disposed on a substrate. The substrate includes a first surface and a second surface. The dual frequency antenna module includes a first antenna, a second antenna, a first connecting portion, and a second connecting portion. The antennas are in symmetry about a central line of the antenna module and disposed on the first surface. Each antenna includes a radiation portion and a feeding portion. The connecting portions are disposed on the first surface and connected to each other in symmetry. A width of each microstrip transmission line of the connecting portions is less than a width of each microstrip transmission line of the antennas. A wavelength of electromagnetic waves transmissible through the microstrip transmission lines of the connecting portions is equal to one half of a wavelength of electromagnetic waves transmissible through the microstrip transmission lines of the first and second antennas

### BACKGROUND

1. Technical Field

The disclosure relates to wireless communication, and particularly to a dual frequency antenna module.

2. Description of Related Art

Dual frequency technology is achieving significant growth due to the ever growing demand for wireless communication products. Dual frequency antennas are widely used in the field of wireless communication. Generally, a dual frequency antenna includes at least two individual antennas. Each antenna needs to be designed as small as possible but the space and radiation requirements of wireless local area network (WLAN) devices employing the antennas imposes strict design conditions concerning isolation between the antennas.

Therefore, what is needed is a dual frequency antenna module to overcome the described shortcoming.

### BRIEF DESCRIPTION OF THE DRAWINGS

FIG. 1 is a front view schematic diagram of a dual frequency antenna module in accordance with an embodiment of the invention.

FIG. 2 is a schematic diagram illustrating dimensions of the dual frequency antenna module of FIG. 1.

FIG. 3 is a graph of test results showing voltage standing wave ratios (VSWRs) of a first antenna of the dual frequency antenna module of FIG. 1.

FIG. 4 is a graph of test results showing the VSWRs of a second antenna of the dual frequency antenna module of FIG. 1.

FIG. 5 is a graph of test results showing isolation between the first antenna and the second antenna of the dual frequency antenna module of FIG. 1.

### DETAILED DESCRIPTION

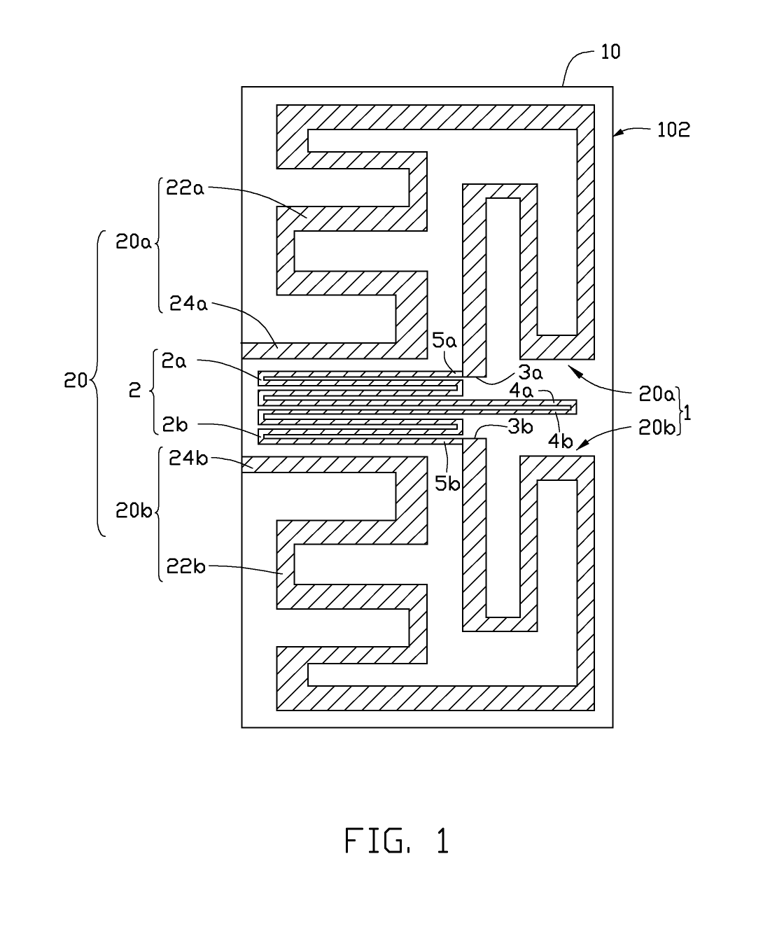

FIG. 1 is a front view of a dual frequency antenna module 20 in accordance with an embodiment.

In this embodiment, the dual frequency antenna module 20 is disposed on a substrate 10. The substrate 10 is a printed circuit board (PCB) and includes a first surface 102 and a second surface (not shown) opposite to the first surface 102. The dual frequency antenna module 20 is made up of copper clad laminate (CCL) medium material. The dual frequency antenna module 20 includes an antenna zone 1 and a connecting zone 2. The antenna zone 1 includes at least a first antenna 20a and a second antenna 20b. The first antenna 20a and the second antenna 20b are symmetrical about a central line of the dual frequency antenna module 20. The connecting zone 2 is between the first antenna 20a and the second antenna 20b and is connected to both.

The first antenna 20a includes a radiation portion 22a, a feeding portion 24a, and a grounding layer (not shown). The second antenna 20b similarly includes a radiation portion 22b, a feeding portion 24b, and the grounding layer.

The radiation bodies 22a, 22b are disposed on the first surface 102, for transmitting and receiving electromagnetic signals. The radiation bodies 22a, 22b are serpentine-shaped and each includes a number of microstrip transmission lines which includes first microstrip transmission lines oriented in a first direction and second microstrip transmission lines oriented in a second direction perpendicular to the first microstrip transmission lines. The first and second microstrip transmission lines are connected to each other in an alternate fashion. A width of each first microstrip transmission line is not equal to a width of the neighboring second microstrip transmission line. In the embodiment, the number of microstrip transmission lines are L-shaped. One end of the radiation portion 22a/22b is connected to the feeding portion 24a/24b and the other end is connected to the connecting zone 2.

In this embodiment, the radiation portion 22a/22b includes seven pieces of L-shaped microstrip transmission lines and a width of each piece of L-shaped microstrip transmission line lengthways along the substrate 10 is different from a width of the L-shaped microstrip transmission line crosswise.

An open end 3a of the first antenna 20a is disposed adjacent to an open end 3b of the second antenna 20b. The feeding portions 24a/24b are disposed on the first surface 102, and electronically connected to the radiation bodies 22a/22b and the grounding layer of the first, second antenna 20a/20b. The feeding portions 24a/24b are used for feeding electromagnetic signals to the radiation bodies 22a/22b. The grounding layer of the first antenna 20a and the second antenna 20b is disposed on the second surface.

The connecting zone 2 includes a first connecting portion 2a and a second connecting portion 2b. The first connecting portion 2a and the second connecting portion 2b are disposed on the first surface 102 and connected to each other. The first connecting portion 2a and the second connecting portion 2b are also symmetrical about the central line. The first connecting portion 2a is connected to the open end 3a of the radiation portion 22a of the first antenna 20a. The second connecting portion 2b is connected to the open end 3b of the radiation portion 22b of the second antenna 20b. In the embodiment, the first connecting portion 2a has the same shape as the shape of the second connecting portion 2b.

The first connecting portion 2a includes a long microstrip transmission line 4a and several short microstrip transmission lines 5a parallel to the long microstrip transmission line 4a which are arranged in a concertinaed fashion. The second connecting portion 2b similarly includes a long microstrip transmission line 4b and several short microstrip transmission lines 5b parallel to the long microstrip transmission line 4b which are arranged in a concertinaed fashion. The number of the microstrip transmission lines of each of the radiation bodies 22a, 22b is greater than the number of the microstrip transmission lines of each of the connecting portions 2a, 2b.

A length of the long microstrip transmission line 4a is equal to one and a half times the length of the short microstrip transmission line 5a. A length of the long microstrip transmission line 4b is equal to one and a half times the length of the short microstrip transmission line 5b. A width of the microstrip transmission line of the first connecting portion 2a is less than a width of the microstrip transmission line of the radiation portion 22a/22b. A width of the microstrip transmission line of the second connecting portion 2b is less than the width of the microstrip transmission line of the radiation portion 22a/22b. In this way, the isolation between the first antenna 20a and the second antenna 20b is improved.

In this embodiment, a wavelength of electromagnetic waves transmissible through the microstrip transmission lines of the connecting zone 2 is equal to one half of a wavelength of electromagnetic waves transmissible through the microstrip transmission lines of the antenna zone 1 and an impedance ratio of the microstrip transmission lines of the connecting zone 2 to the antenna zone 1 is equal to 1:3. A radiation field produced by a coupling effect of the first, second radiation bodies 22a, 22b improves the radiation efficiency of the dual frequency antenna module 20. In other words, the first, second radiation bodies 22a and 22b reduce the surface area of the dual frequency antenna module 20, and improve the radiation efficiency of the dual frequency antenna module 20. In this embodiment, the radiation bodies 22a and 22b have a shape which is selected from a group of consisting of an s-shaped configuration, a w-shaped configuration, and a u-shaped configuration.

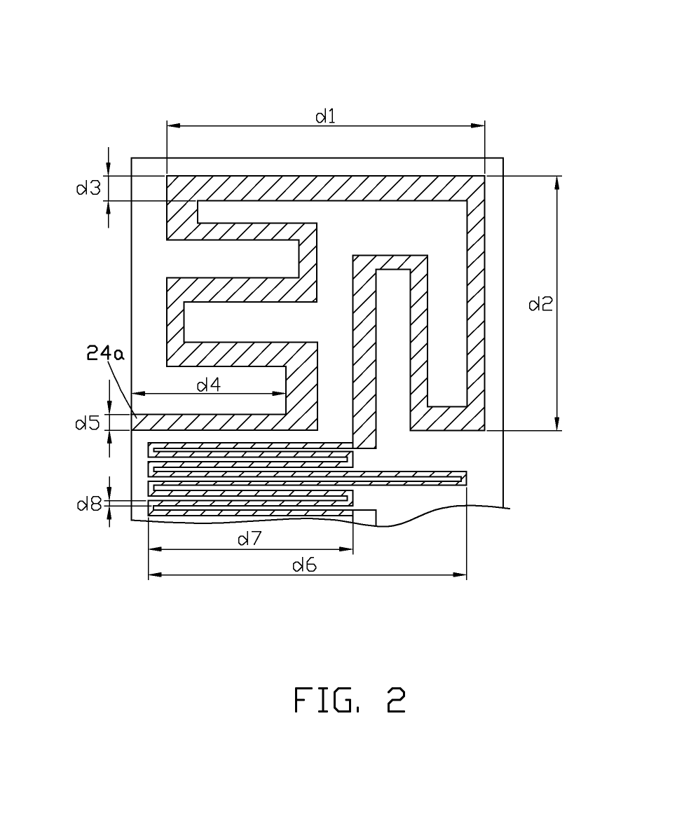

FIG. 2 illustrates various dimensions of the dual frequency antenna module 20 of FIG. 1.

All dimensions of all parts of the first antenna 20a are the same as the corresponding dimensions of the second antenna 20b and only the dimensions of the first antenna 20a will be explained. A total length d1 of the first radiation portion 22a is 8.5 millimeters (mm), and a total width d2 of the first radiation portion 22a is 8 mm. The width of each piece of L-shaped microstrip transmission line of the first radiation portion 22a in the lengthways direction is 0.8 mm and the width of the transmission line of the first radiation portion 22a in the crosswise direction is 0.5 mm. The feeding portion 24a is rectangular. A length d4 of the feeding portion 24a is 4.2 mm, and a width d5 of the feeding portion 24a is 0.5 mm.

All dimensions of all parts of the first connecting portion 2a are the same as the corresponding dimensions of the second connecting portion 2b. A length d6 of the long microstrip transmission line of the first connecting portion 2a is 8.4 mm, a length d7 of the short microstrip transmission line of the first connecting portion 2a is 5.6 mm, and the width d8 of the long, short microstrip transmission line of the first connecting portion 2a is 0.1 mm.

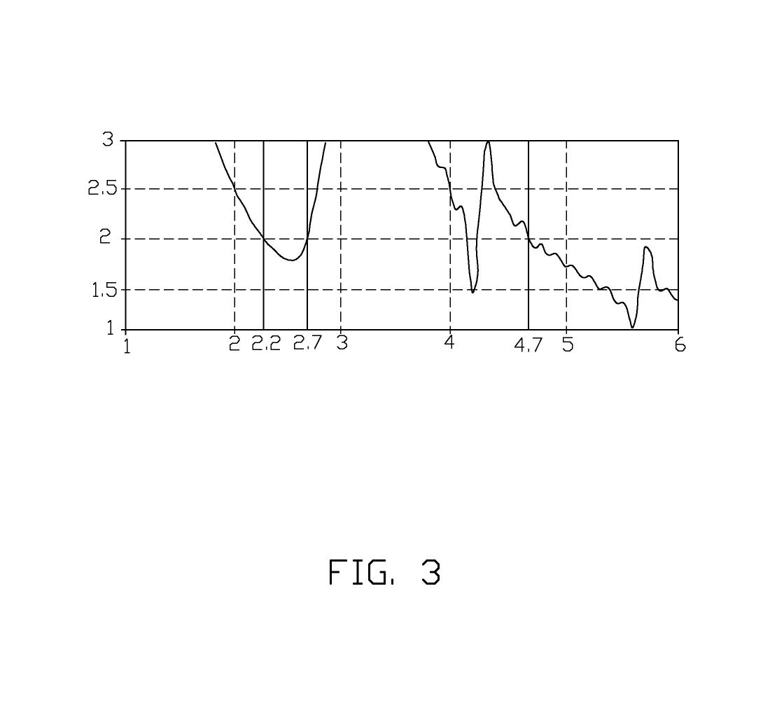

FIG. 3 is a graph of test results showing voltage standing wave ratios (VSWRs) of the first antenna 20a of the dual frequency antenna module 20 of FIG. 1. The horizontal axis represents the frequency (in GHz) of the electromagnetic signals traveling through the first antenna 20a, and the vertical axis represents amplitude of the VSWRs. A curve shows the amplitude of the VSWRs of the first antenna 20a at various working frequencies. As shown in FIG. 3, the first antenna 20a performs well when working at frequency bands of 2.2-2.7 GHz and 4.7-6.0 GHz. The amplitude values of the VSWRs in the band pass frequency range are less than 2, which indicates that the first antenna 20a complies with application requirements of the dual frequency antenna module 20.

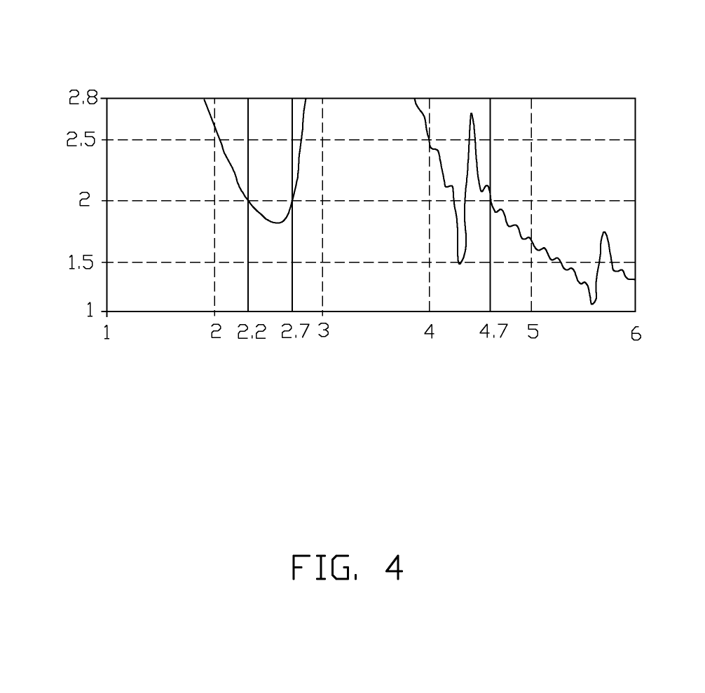

FIG. 4 is a graph of test results showing VSWRs of the second antenna 20b of the dual frequency antenna module 20 of FIG. 1. The horizontal axis represents the frequency (in GHz) of the electromagnetic signals traveling through the second antenna 20b, and the vertical axis represents amplitude of the VSWRs. A curve shows the amplitude of the VSWRs of the second antenna 20b at working frequencies. As shown in FIG. 4, the second antenna 20b performs well when working at frequency bands of 2.2-2.7 GHz and 4.7-6.0 GHz. The amplitude values of the VSWRs in the band pass frequency range are less than 2, which indicates that the second antenna 20b complies with application requirements of the dual frequency antenna module 20.

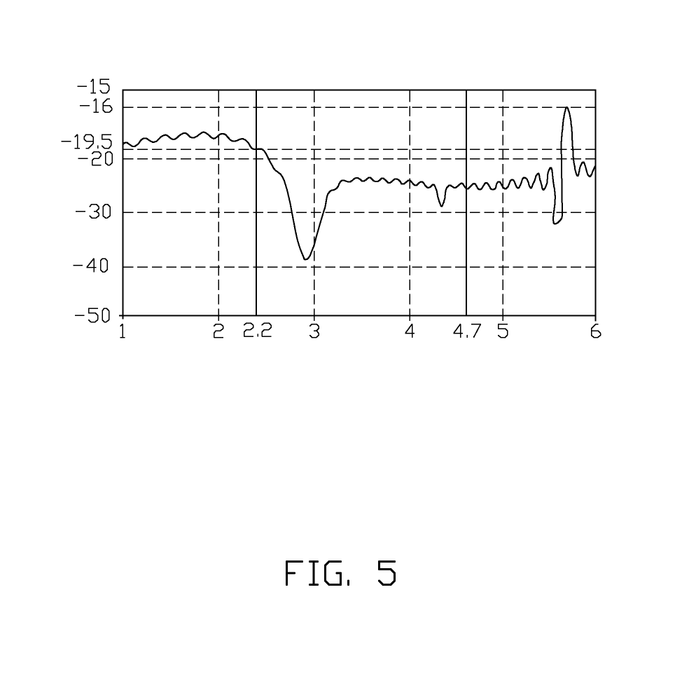

FIG. 5 is a graph of test results showing isolation between the first antenna 20a and the second antenna 20b of the dual frequency antenna module 20 of FIG. 1. The horizontal axis represents the frequency (in GHz) of the electromagnetic signals traveling through the dual frequency antenna module 20, and the vertical axis represents the amplitude of the isolation. As shown in FIG. 5, a curve shows isolation between the first antenna 20a and the second antenna 20b is at the greatest −19.5 dB when the dual frequency antenna module 20 works at frequency band of 2.2-2.7 GHz. Isolation between the first antenna 20a and the second antenna 20b is at the greatest −16 dB when the dual frequency antenna module 20 works at frequency band of 4.7-6.0 GHz. The smallest isolation values of the two bands are less than −10 dB, which indicates that the dual frequency antenna module 20 complies with application requirements of a dual frequency antenna.

In this embodiment, the first radiation portion 22a and the second radiation portion 22b are serpentine-shaped. Therefore, the compactness of the dual frequency antenna module 20 is optimal. The dual frequency antenna module 20 works in two frequency bands synchronously, such as 2.4 GHz and 5.0 GHz.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A dual frequency antenna module comprising:
a substrate comprising a first surface and an opposite second surface; and
a dual frequency antenna comprising: a grounding layer formed on the second surface;
a first antenna;
a second antenna, the first antenna and the second antenna being symmetrical about a central line of the dual frequency antenna, each of the first and second antennas comprising:
a radiation portion configured for transmitting and receiving electromagnetic signals, the radiation portion comprising a plurality of microstrip transmission lines including first microstrip transmission lines oriented in a first direction and second microstrip transmission lines oriented in a second direction perpendicular to the first direction, the first and second microstrip transmission lines connected to each other in an alternate fashion; and
a feeding portion connected between the grounding layer and the radiation portion, and configured for feeding electromagnetic signals to the radiation portion;
a first connecting portion; and
a second connecting portion, the first and second connecting portions being connected with each other and arranged on the first surface between the radiation portions in symmetry about the central line, each of the first and second connecting portions comprising a plurality of microstrip transmission lines arranged in a concertinaed fashion;
wherein a width of each microstrip transmission line of the first and second connecting portions is less than a width of each microstrip transmission line of the first and second antennas, and a wavelength of electromagnetic waves transmissible through the microstrip transmission lines of the connecting portions is equal to one half of a wavelength of electromagnetic waves transmissible through the microstrip transmission lines of the first and second antennas.

2. The dual frequency antenna as recited in claim 1, wherein a width of each first microstrip transmission line is not equal to a width of the neighboring second microstrip transmission line.

3. The dual frequency antenna as recited in claim 1, wherein the number of the microstrip transmission lines of each radiation portion is greater than the number of the microstrip transmission lines of each of the connecting portions.

4. The dual frequency antenna as recited in claim 1, wherein the first connecting portion is connected to the first antenna and the second connecting portion is connected to the second antenna.

5. The dual frequency antenna as recited in claim 1, wherein each feeding portion perpendicularly extends from the first surface to the second surface.

6. The dual frequency antenna as recited in claim 1, wherein an impedance ratio of each of the first and second connecting portions to each of the first and second antennas is equal to 1:3.

7. The dual frequency antenna as recited in claim 1, wherein the microstrip transmission lines of each of the connecting portions include a long microstrip transmission line and a plurality of short microstrip transmission lines parallel to the long microstrip transmission line, and a length of the long microstrip transmission line is equal to one and a half times a length of each short microstrip transmission line.
